(19) United States
(12) Patent Application Publication
(10) Pub. No.: US 2022/0270630 A1
(43) Pub. Date: Aug. 25, 2022

(54) NOISE SUPPRESSION APPARATUS, METHOD AND PROGRAM FOR THE SAME

(71) Applicant: NIPPON TELEGRAPH AND TELEPHONE CORPORATION, Tokyo (JP)

(72) Inventors: Hiroaki ITO, Tokyo (JP); Kazunori KOBAYASHI, Tokyo (JP)

(73) Assignee: NIPPON TELEGRAPH AND TELEPHONE CORPORATION, Tokyo (JP)

(21) Appl. No.: 17/438,351

(22) PCT Filed: Feb. 28, 2020
(86) PCT No.: PCT/JP2020/008217

§ 371 Date: May 3, 2022

(30) Foreign Application Priority Data
Mar. 13, 2019 (JP) 2019-046203

(51) Int. Cl. G10L 21/0224; G10L 25/84

(52) U.S. Cl. CPC G10L 21/0224; G10L 25/84; G10L 2021/02166

(57) ABSTRACT

The present invention provides a noise suppression device and so on for improving the estimation precision of a spatial covariance matrix and improving a noise suppression performance. The noise suppression device includes a noise interval detection unit which, on the assumption that a direction from which noise arrives is unknown, determines whether or not a target signal, which is a sound signal that arrives from a predetermined direction and is not subject to suppression, is included in an observation signal, and a noise suppression updating unit that uses an after-observation signal, which is an observation signal acquired at a time after a point at which the noise interval detection unit determines that the target signal is no longer included, to update a beam pattern so as not to emphasize sound issued from a direction in which sound included in the after-observation signal was issued.

### TECHNICAL FIELD

The present invention relates to a noise suppression device, and a method and a program therefor, with which noise is suppressed from an observation signal recorded by a plurality of microphones in an environment where sound (also referred to hereafter as “target sound”) issued by a target sound source and background noise coexist so that only the target sound is extracted.

### BACKGROUND ART

NPL 1 is available as prior art relating to noise suppression technology.

NPL 1 will be described using FIG. 1.

A spatial covariance calculation unit 11 receives an observation signal as input and calculates a time-frequency mask expressing whether a target voice or noise is dominant at each time-frequency point. Next, using the time-frequency mask, the spatial covariance calculation unit 11 calculates a feature value of an observation signal of a time-frequency point at which the target voice is dominant. On the basis of the calculated feature value, the spatial covariance calculation unit 11 calculates a target signal spatial covariance matrix under noise, which is a spatial covariance matrix of an observation signal including both the target voice and noise. The spatial covariance calculation unit 11 also uses the time-frequency mask to calculate a feature value of an observation signal of a time-frequency point at which noise is dominant. Then, on the basis of the calculated feature value, the spatial covariance calculation unit 11 calculates a noise spatial covariance matrix, which is a spatial covariance matrix of an observation signal including only noise.

Next, a noise suppression unit 13 calculates a noise suppression filter on the basis of the observation signals, the target signal spatial covariance matrix under noise, and the noise spatial covariance matrix, and by applying the calculated noise suppression filter to the observation signals, estimates a signal (also referred to hereafter as a “target signal”) corresponding to the target voice.

A method based on spatial feature value clustering of observation signals (see NPL 1, for example), a method based on a deep neural network (DNN) (see NPL 2, for example), and so on are known as mask calculation methods.

### CITATION LIST

### Non Patent Literature

[NPL 1] Takuya Higuchi, Nobutaka Ito, Takuya Yoshioka, Tomohiro Nakatani, “Robust MVDR beamforming using time-frequency masks for online/offline ASR in noise”, ICASSP 2016, pp. 5210-5214, 2016.
[NPL 2] Jahn Heymann, Lukas Drude, Reinhold Haeb-Umbach, “Neural network based spectral mask estimation for acoustic beamforming”, ICASSP 2016, pp. 196-200, 2016.

### SUMMARY OF THE INVENTION

### Technical Problem

In the prior art, it is necessary to calculate the target signal spatial covariance matrix under noise using an observation signal of an interval in which the target signal exists and calculate the noise spatial covariance matrix using an observation signal of an interval in which only signals (also referred to hereafter as “noise signals”) corresponding to noise exist.

From observation signals alone, however, it is impossible to acquire information indicating the interval in which the target signal exists and the interval in which only noise signals exist. Therefore, a problem exists in that the calculation precision of the spatial covariance matrices decreases, leading to deterioration of the noise suppression performance.

An object of the present invention is to provide a noise suppression device, and a method and a program therefor, with which, by detecting an utterance interval from a signal emphasizing sound issued from a target direction on the condition that the direction (also referred to hereafter as the “target direction”) of a target sound source is known, the detection precision of an interval in which only noise signals exist is improved, leading to an improvement in the estimation precision of a spatial covariance matrix and an improvement in a noise suppression performance.

### Means for Solving the Problem

To solve the problem described above, according to one aspect of the present invention, a noise suppression device includes a noise interval detection unit which, on the assumption that a direction from which noise arrives is unknown, determines whether or not a target signal, which is a sound signal that arrives from a predetermined direction and is not subject to suppression, is included in an observation signal, and a noise suppression updating unit that uses an after-observation signal, which is an observation signal acquired at a time after a point at which the noise interval detection unit determines that the target signal is no longer included, to update a beam pattern so as not to emphasize sound issued from a direction in which sound included in the after-observation signal was issued.

To solve the problem described above, according to another aspect of the present invention, a noise suppression device includes a direction emphasizing unit that acquires a target direction emphasizing signal by emphasizing sound arriving from a direction of a target sound source, the sound being included in an observation signal, a noise interval detection unit that detects a noise interval from the target direction emphasizing signal, a spatial covariance matrix calculation unit that calculates a noise spatial covariance matrix using an after-observation signal, which is an observation signal acquired at a time after a start time of the noise interval, and a noise suppression unit that uses the noise spatial covariance matrix to suppress sound issued from a direction in which sound included in the after-observation signal was issued.

### Effects of the Invention

According to the present invention, effects of an improvement in the estimation precision of a spatial covariance matrix and an improvement in a noise suppression performance are achieved.

### BRIEF DESCRIPTION OF DRAWINGS

FIG. 1 is a function block diagram of a noise suppression device according to the prior art.

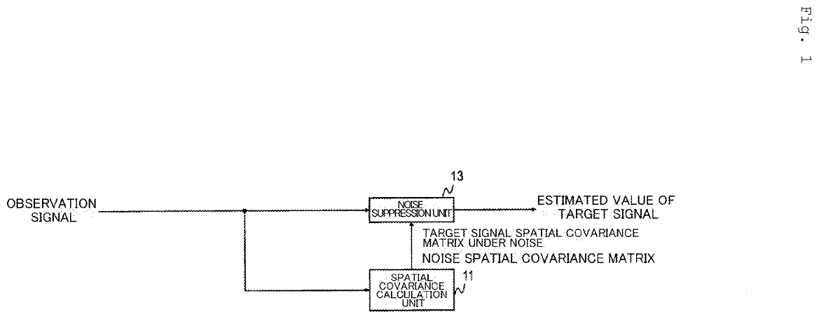

FIG. 2 is a function block diagram of a noise suppression device according to a first embodiment.

FIG. 3 is a view showing an example of a processing flow of the noise suppression device according to the first embodiment.

FIG. 4 is a view showing an example of the power of an observation signal, the power of a target direction emphasizing signal, and the power of a target signal.

FIG. 5 is a view showing an image of an operation of the first embodiment.

### DESCRIPTION OF EMBODIMENTS

Embodiments of the present invention will be described below. Note that in the figures used in the following description, constituent parts having identical functions and steps in which identical processing is performed have been allocated identical reference symbols, and duplicate description thereof has been omitted. Unless specified otherwise, it is assumed that processing performed in units of elements of a vector or a matrix is applied to all of the elements of the vector or the matrix.

### Point of First Embodiment

The detection precision of a noise interval is improved by detecting an utterance interval from a signal (also referred to hereafter as a “target direction emphasizing signal”) emphasizing sound arriving from a target direction, on the condition that the target direction is known.

Further, the estimation precision of a noise spatial covariance matrix, which is required for noise suppression processing, is improved by using a noise interval detected with a high degree of precision.

Noise is suppressed by the following processing 1. to 3., for example.
1. The target direction emphasizing signal is acquired by designing a filter (also referred to hereafter as a target direction emphasizing filter) for “emphasizing sound arriving from a known target direction” and applying the target direction emphasizing filter to an observation signal. As a result, a target voice is slightly emphasized, whereby a signal in which noise has been suppressed is acquired.
2. The power of the target direction emphasizing signal is subjected to threshold processing, and when it is determined that an interval is an interval in which sound does not arrive from the known target direction, a filter (also referred to hereafter as a noise suppression filter) is updated so as not to emphasize the direction from which the sound collected in that interval arrives. Updating of the noise suppression filter is stopped when sound arrives from the known target direction.
3. The noise suppression filter is constantly applied to (multiplied by) the observation signals.

By performing the processing of 1. to 3. continuously, the noise suppression filter is gradually updated, and as a result, the precision of noise suppression gradually improves.

A noise suppression device for realizing the processing of 1. to 3. will now be described.

### First Embodiment

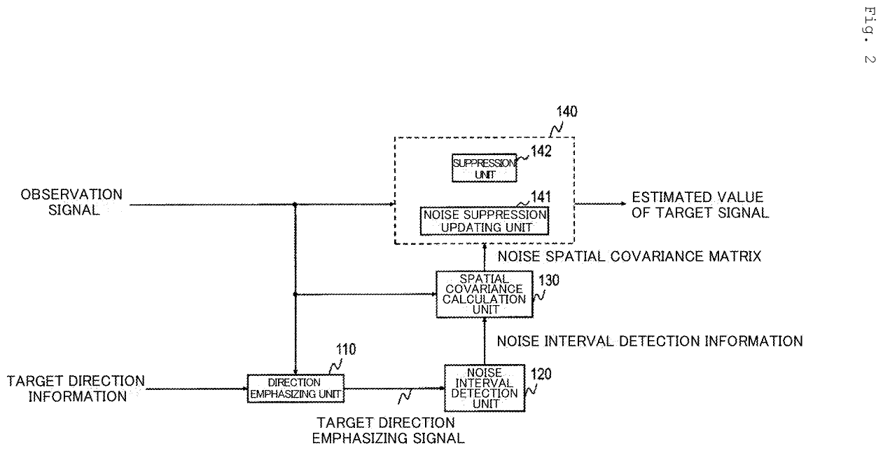

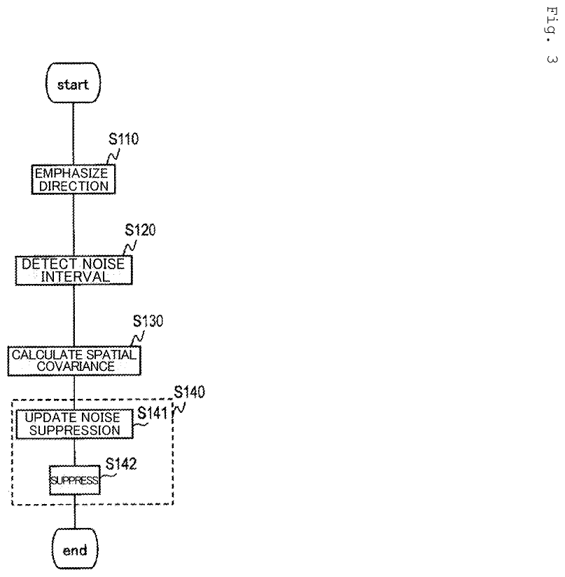

FIG. 2 is a function block diagram of a noise suppression device according to a first embodiment, and FIG. 3 shows a processing flow thereof.

The noise suppression device includes a direction emphasizing unit 110, a noise interval detection unit 120, a spatial covariance matrix calculation unit 130, and a noise suppression unit 140.

The noise suppression device receives an observation signal and target direction information as input, extracts a target signal by suppressing noise included in the observation signal, and outputs the target signal. Note that the observation signal is an acoustic signal observed by sound collecting means (for example, a microphone array constituted by a plurality of microphones). An output signal of the sound collecting means may be input as is, or an output signal stored in a storage device of some kind may be read and input, or the output signal of the sound collecting means may be input after being subjected to processing of some kind.

Note that a prerequisite of this embodiment is that the direction (a target direction) of a target sound source relative to the sound collecting means (a microphone array, for example) is known. Further, it is assumed that the direction from which noise arrives is unknown. In this embodiment, target direction information includes information indicating the target direction relative to the sound collecting means. In this embodiment, the target sound source is set as a speaker (also referred to hereafter as a “target speaker”), the target sound is set as a voice (also referred to hereafter as a “target voice”) uttered by the target speaker, and the target signal is set as a signal corresponding to the target voice. Note, however, that the present invention is not limited thereto, and the target sound source may be a sound source such as a musical instrument or a sound source such as a playback device or the like of some kind rather than a speaker, while the target sound may be a sound other than a voice.

The noise suppression device is a special device formed by reading a special program to a known or general-purpose computer having a central calculation processing device (a CPU; Central Processing Unit), a main storage device (a RAM; Random Access Memory), and so on, for example. The noise suppression device executes various processing under the control of the central calculation processing device, for example. Data input into the noise suppression device and data acquired during the processing are stored in the main storage device, for example, and the data stored in the main storage device are read to the central calculation processing device and used in other processing as needed. At least some of the respective processing units of the noise suppression device may be formed from hardware such as an integrated circuit. Respective storage units provided in the noise suppression device may be constituted by a main storage device such as a RAM (Random Access Memory) or middleware such as a relational database or a key-value store, for example. Note, however, that the storage units do not necessarily have to be provided in the interior of the noise suppression device, and instead, the storage units may be constituted by an auxiliary storage device formed from a hard disk, an optical disk, or a semiconductor memory element such as a flash memory and provided on the exterior of the noise suppression device.

The respective units will be described below.

### Direction Emphasizing Unit 10

The direction emphasizing unit 110 receives the observation signal and the target direction information as input, acquires the target direction emphasizing signal (S110) by emphasizing sound arriving from the target direction, the sound being included in the observation signal, on the basis of the target direction information through beamforming processing or the like, and outputs the acquired target direction emphasizing signal. Note that a delay-and-sum array, an adaptive array, or the like may be considered as a beamforming technique, but any beamforming technique may be used. The beamforming technique of NPL 1, for example, can be used.

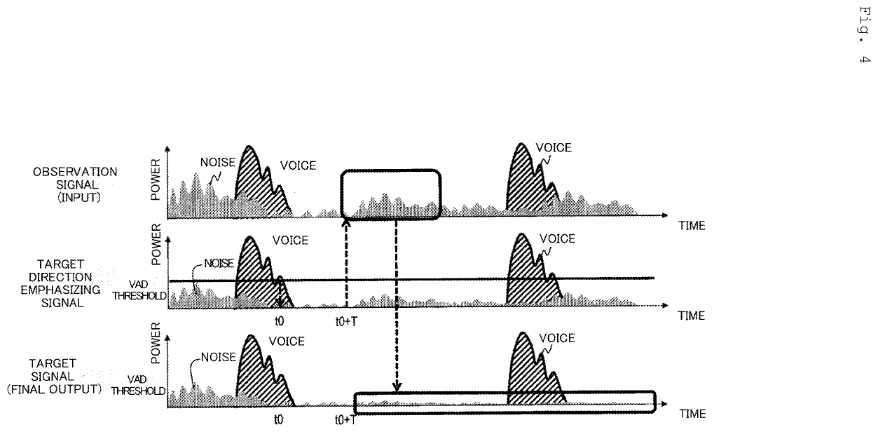

FIG. 4 shows an example of the power of the observation signal and the power of the target direction emphasizing signal.

### Noise Interval Detection Unit 120

The noise interval detection unit 120 receives the target direction emphasizing signal as input, detects a noise interval from the target direction emphasizing signal (S120), and outputs noise interval detection information. The noise interval detection information is information indicating whether or not the target direction emphasizing signal of a certain time denotes a noise interval. When noise interval detection processing is performed in each frame, for example, information (1, for example) indicating that a non-noise interval is included or information (0, for example) indicating that a noise interval is included is output in each frame. Further, information indicating the start time and/or the end time of the non-noise interval and/or the noise interval, and information indicating the length of the non-noise interval and/or the noise interval, for example, may also be used as the noise interval detection information. For example, if information indicating the start time of a non-noise interval and the length of the non-noise interval is known, the non-noise interval can be identified, and accordingly, times other than the non-noise interval can be determined as noise intervals.

For example, the noise interval detection unit 120 determines whether an interval is a voice interval or a non-voice interval by performing voice interval detection (Voice Activity Detection, VAD) on the target direction emphasizing signal. Note that any voice interval detection technique may be used as the voice interval detection technique. When a non-voice interval is maintained for a fixed time from a point at which a voice interval switches to a non-voice interval (for example, the point at which 1, indicating that the noise interval detection information is included in a voice interval, changes to 0, indicating that the information is not included in a voice interval), the noise interval detection unit 120 considers the point following the elapse of the fixed time as the start of the noise interval and outputs the noise interval detection information. Note that the fixed time may be set at 0, and the point at which a voice interval switches to a non-voice interval may be considered as the start of the noise interval. Also note that although various techniques may be considered as the VAD technique, any VAD technique may be used. In the example of FIG. 4, the point at which a voice interval switches to a non-voice interval is set as a time t0, the fixed time is set as T, and a time t0+T is set as the start time of the noise interval.

Since the target signal is not included in an observation signal of a noise interval, the noise interval detection unit 120 may also be said to determine whether or not the target signal is included in the observation signal and output the noise interval detection information as the determination result. As noted above, the target signal is a signal (a target signal) corresponding to the target sound and a sound signal that arrives from a predetermined direction (the target direction) and is not therefore subject to suppression.

### Spatial Covariance Matrix Calculation Unit 130

The spatial covariance matrix calculation unit 130 receives the observation signal and the noise interval detection information as input, calculates a noise spatial covariance matrix (S130) using an observation signal (also referred to hereafter as an “after-observation signal”) acquired at a time after the start time of the noise interval, and outputs the calculated noise spatial covariance matrix. Identical processing to that of the spatial covariance matrix calculation unit according to the prior art is performed, but only the spatial covariance matrix of the noise is updated. Note that observation signals from non-noise intervals are not used to calculate the noise spatial covariance matrix, and the noise spatial covariance matrix is calculated and updated using only the after-observation signal.

For example, the spatial covariance matrix calculation unit 130 remains in a standby state in a non-noise interval and starts to calculate a feature value of the after-observation signal following the start time of the noise interval. The spatial covariance matrix calculation unit 130 may be configured so as to reenter the standby state when a non-noise interval occurs again.

On the basis of the calculated feature value, the spatial covariance matrix calculation unit 130 calculates a noise spatial covariance matrix, which is a spatial covariance matrix of the after-observation signal including only noise.

The noise spatial covariance matrix is calculated using the method of NPL 1, for example. For example, when an index expressing frequency is set as f, an index expressing time is set as t, m is set as m=1, 2, . . . , M, a time-frequency component of an observation signal observed by an m^{th} microphone of a microphone array constituted by M microphones is set as y_{f,t,m}, a vector of the time-frequency components of the observation signals observed by the M microphones is set as Y_{f, t}=[Y_{f, t, 1}, Y_{f, t,2}, . . . , Y_{f, t, m}], and the noise interval detection information is set as λₜ, a noise spatial covariance matrix R_{f}⁽ⁿ⁾ is calculated as follows.

$${R}_{f}^{( n )} = \frac{1}{{\sum }_{t} {λ}_{t}} {\sum }_{t} {λ}_{t} {y}_{f , t} {y}_{f , t}^{H} \qquad [ Formula 1 ]$$

Here, superscript H represents a Hermitian matrix, and superscript (n) is a suffix indicating use for noise. The noise interval detection information λₜ takes 1 when the time t is included in a non-noise interval and 0 when the time t is included in a noise interval.

### Noise Suppression Unit 140

The noise suppression unit 140 receives the observation signal and the noise spatial covariance matrix as input, suppresses noise (S140) using a similar method to the prior art, and outputs the target signal.

For example, a noise suppression updating unit 141 of the noise suppression unit 140 calculates a noise suppression filter on the basis of the observation signal, a target signal spatial covariance matrix under noise, and the noise spatial covariance matrix (S141). Note that it is assumed that a predetermined matrix (a preset matrix) is used as the target signal spatial covariance matrix under noise, and that the value updated successively by the spatial covariance matrix calculation unit 130 is used for the noise spatial covariance matrix. The noise suppression filter is calculated using the method of NPL 1, for example. For example, when the target signal spatial covariance matrix under noise (a preset matrix) is set as R_{f}^{(s+n)}, a target signal spatial covariance matrix (not under noise) is set as R_{f}^{(s)}, and a steering vector is set as a, a noise suppression filter w_{f} is calculated as follows.

$${R}_{f} = {R}_{f}^{( s + n )} - {R}_{f}^{( n )} \qquad [ Formula 2 ]$$

$${w}_{f} = \frac{{R}_{f}^{- 1} {a}_{f}}{{a}_{f}^{H} {R}_{f}^{- 1} {a}_{f}} \qquad [ Formula 3 ]$$

Note that the steering vector a may be determined as an eigenvector that gives the maximum eigenvalue of the target signal spatial covariance matrix R, or may be determined from arrival time differences between the microphones. When determined from the arrival time differences, the steering vector is expressed as follows, for example.

$${a}_{f} = [ {e}^{- j 2 π f \frac{{d}_{1} sin θ}{c}} , . . . , {e}^{- j 2 π f \frac{{d}_{M} sin θ}{c}} ] \qquad [ Formula 4 ]$$

Here, θ expresses the target direction, d expresses the distance between the microphones, and c expresses the speed of sound.

In the spatial covariance matrix calculation unit 130, the noise spatial covariance matrix is updated using the after-observation signal, and therefore the point in time at which the noise interval detection unit 120 determines that the observation signal no longer includes the target signal (i.e. the start time of the noise interval) is used as a reference. The noise suppression updating unit 141 of the noise suppression unit 140 uses the after-observation signal, which is an observation signal acquired at a time after this reference, to update a beam pattern (the filter coefficient of the noise suppression filter) so as not to emphasize sound issued from the direction in which the sound included in the after-observation signal was issued.

A suppression unit 142 of the noise suppression unit 140 suppresses noise included in the observation signal (S142) by applying the calculated noise suppression filter to the observation signal, thereby estimating the target signal, and then outputs the estimated target signal. For example, a target signal \hat{ }S_{f,t} is estimated as follows.

\hat{ }S_{f,t} =W^{H}_{f, t}Y_{f, t}

The noise suppression filter is updated using the after-observation signal, and therefore sound issued from the direction in which the sound included in the after-observation signal was issued can be suppressed. It can be seen in FIG. 4 that the noise spatial covariance matrix is updated from the time t0+T onward, with the result that the target signal is estimated with a high degree of precision.

With this configuration, the noise suppression unit 140 suppresses sound (noise) issued from the direction in which the sound included in the after-observation signal was issued from the observation signal using the noise spatial covariance matrix.

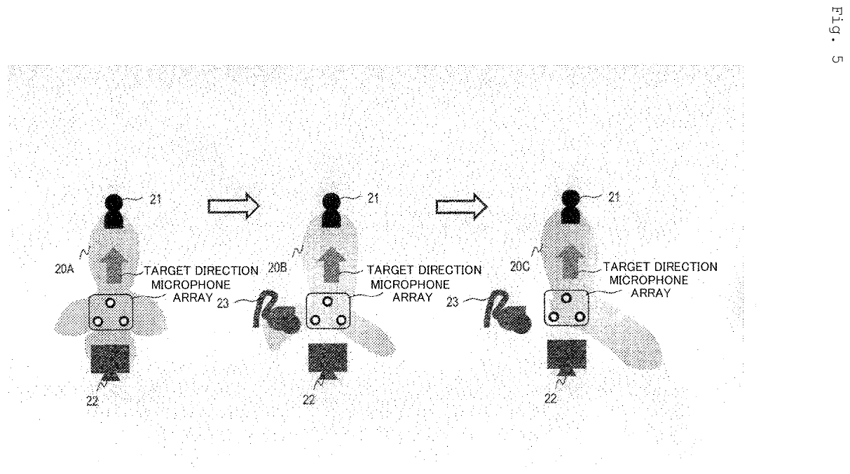

FIG. 5 shows an image of an operation of the first embodiment.

A beam pattern 20A denotes a beam patterm immediately after the start of an operation. Although noise based on a voice from a TV 22 exists, the characteristics of the noise cannot be reflected, and therefore the noise suppression performance is not high. When a non-voice interval is maintained for a fixed time following a point at which an utterance by a target speaker 21 ends such that a voice interval switches to a non-voice interval, the point following the elapse of the fixed time is considered as the start of a noise interval, and updating of the noise spatial covariance matrix is begun. The noise suppression filter is updated on the basis of the updated noise spatial covariance matrix, whereby a beam pattern 20B reflecting the characteristics of the noise based on the voice from the TV is formed. However, the beam pattern 20B cannot reflect the characteristics of new noise issued from a vacuum cleaner 23. When the noise interval continues, the noise suppression device continues to update the noise spatial covariance matrix and update the noise suppression filter on the basis of the updated noise spatial covariance matrix, and as a result, a beam pattern 20C reflecting the characteristics of the noise based on the voice from the TV 22 and the new noise issued from the vacuum cleaner 23 is formed.

### Effects

With the configuration described above, the estimation precision of the spatial covariance matrix is improved, leading to an improvement in the noise suppression performance. When the noise spatial covariance matrix begins to be updated, the noise suppression performance improves, and as a result, a voice arriving from the target direction can be emphasized more favorably. In this embodiment, a noise interval can be extracted from the observation signal, and therefore the spatial characteristics of the noise can be estimated in a sophisticated manner. Furthermore, by estimating the spatial covariance matrix on the basis of the estimated spatial characteristics of the noise, the performance of the voice emphasizing processing can be improved. By causing an acoustic model of a voice recognition engine to adaptively learn the spatial characteristics of the use environment using the estimated spatial characteristics of the noise, it is possible to improve the voice recognition performance in the use environment of the user.

### Other Modified Examples

The present invention is not limited to the embodiments and modified examples described above. For example, the various processing described above does not have to be executed in time series in accordance with the description and may, depending on the processing capacity of the devices that execute the processing or as required, be executed in parallel or individually. The processing may also be modified as appropriate within a scope that does not depart from the spirit of the present invention.

### Program and Recording Medium

Further, the various processing functions of the devices described in the above embodiments and modified examples may be realized by a computer. In this case, the processing content of the functions to be provided in the respective devices is described by a program. Then, by having the computer execute the program, the various processing functions of the respective devices are realized on the computer.

The program describing the processing content can be recorded on a computer-readable recording medium. Examples of computer-readable recording media include a magnetic recording device, an optical disk, a magneto-optical recording medium, a semiconductor memory, and so on.

Further, the program is distributed by selling, transferring, lending, or otherwise distributing a portable recording medium such as a DVD or a CD-ROM on which the program is recorded. The program may also be distributed by storing the program in a storage device of a server computer and transferring the program from the server computer to another computer over a network.

For example, the computer that executes the program first temporarily stores the program, which has been recorded on a portable recording medium or transferred from a server computer, in a storage unit provided therein. Then, when the processing is to be executed, the computer reads the program stored in the storage unit and executes processing corresponding to the read program. Further, as another embodiment of the program, the computer may read the program directly from the portable recording medium and execute processing corresponding to the program. Furthermore, the computer may execute processing corresponding to the received program successively each time the program is transferred thereto from the server computer. Alternatively, the processing described above may be executed by a so-called ASP (Application Service Provider) service in which, instead of transferring the program from the server computer to the computer, the processing functions are realized only by issuing execution commands and acquiring results. Note that the program is assumed to include information that is equivalent to a program and used for processing by an electronic computer (data that are not direct commands issued to a computer but have properties defining computer processing, or the like).

Furthermore, although it has been assumed that the respective devices are configured by executing a predetermined program on a computer, at least a part of the processing content thereof may be realized by hardware.

1. A noise suppression device comprising: a noise interval detection unit which, on the assumption that a direction from which noise arrives is unknown, determines whether or not a target signal which is a sound signal that arrives from a predetermined direction and is not subject to suppression is included in an observation signal; and a noise suppression updating unit that uses an after-observation signal which is an observation signal acquired at a time after a point at which the noise interval detection unit determines that the target signal is no longer included to update a beam pattern so as not to emphasize sound issued from a direction in which sound included in the after-observation signal was issued.

2. A noise suppression device comprising: a direction emphasizing unit that acquires a target direction emphasizing signal by emphasizing sound arriving from a direction of a target sound source, the sound being included in an observation signal; a noise interval detection unit that detects a noise interval from the target direction emphasizing signal; a spatial covariance matrix calculation unit that calculates a noise spatial covariance matrix using an after-observation signal which is an observation signal acquired at a time after a start time of the noise interval; and a noise suppression unit that uses the noise spatial covariance matrix to suppress sound issued from a direction in which sound included in the after-observation signal was issued.

3. The noise suppression device according to claim 2, wherein the noise interval detection unit performs voice interval detection processing on the target direction emphasizing signal and, when a non-voice interval is maintained for a fixed time following a point at which a voice interval switches to a non-voice interval, detects the point following the elapse of the fixed time as the start time of the noise interval.

4. The noise suppression device according to claim 2 or 3, wherein the noise suppression unit comprises: a noise suppression updating unit that calculates a noise suppression filter on the basis of the observation signal, a predetermined target signal spatial covariance matrix under noise, and the noise spatial covariance matrix; and a suppression unit that applies the noise suppression filter to the observation signal.

5. A noise suppression method comprising: a noise interval detecting step in which, on the assumption that a direction from which noise arrives is unknown, a determination is made as to whether or not a target signal which is a sound signal that arrives from a predetermined direction and is not subject to suppression is included in an observation signal; and a noise suppression updating step in which an after-observation signal which is an observation signal acquired at a time after a point at which the target signal is determined to be no longer included in the noise interval detection step is used to update a beam pattern so as not to emphasize sound issued from a direction in which sound included in the after-observation signal was issued.

6. A noise suppression method comprising: a direction emphasizing step for acquiring a target direction emphasizing signal by emphasizing sound arriving from a direction of a target sound source, the sound being included in an observation signal; a noise interval detecting step for detecting a noise interval from the target direction emphasizing signal; a spatial covariance matrix calculating step for calculating a noise spatial covariance matrix using an after-observation signal which is an observation signal acquired at a time after a start time of the noise interval; and a noise suppressing step for suppressing sound issued from a direction in which sound included in the after-observation signal was issued using the noise spatial covariance matrix.

7. A program for causing a computer to function as the noise suppression device according to any of claims 1-4.
